(19) United States
(12) Patent Application Publication
(10) Pub. No.: US 2026/0153931 A1
(43) Pub. Date: Jun. 4, 2026

(54) FORCE SENSOR DEVICE

(71) Applicant: Shanghai Tianma Micro-Electronics Co., Ltd., Shanghai (CN)

(72) Inventors: Sho ONOSE, Kawasaki (JP); Shin TAKEUCHI, Kawasaki (JP); Harue AZUMA, Kawasaki (JP); Hiroshi HAGA, Kawasaki (JP)

(21) Appl. No.: 19/401,710

(22) Filed: Nov. 26, 2025

(30) Foreign Application Priority Data
Nov. 29, 2024 (JP) 2024-208667

(51) Int. Cl. G06F 3/01; G01L 1/22; G06F 3/041

(52) U.S. Cl. CPC G06F 3/016; G01L 1/2218; G06F 3/0414

(57) ABSTRACT

A force sensor device includes a first stage, a second stage disposed behind the first stage with a gap therebetween, a plurality of beams fixed to the second stage and the first stage, and strain gauges attached on the plurality of beams. The first stage is configured to move relatively to the second stage in response to a force applied from the front. The plurality of fixed beams are configured to deform with the movement of the first stage. Each of the plurality of beams includes a decreasing region where at least either the width or the thickness monotonically decreases from a first fixing point to one of the first stage and the second stage toward a second fixing point to the other one of the first stage and the second stage. Each strain gauge is attached within the decreasing region.

### CROSS-REFERENCE TO RELATED APPLICATIONS

This non-provisional application claims priority under 35 U.S.C. § 119(a) on Patent Application No. 2024-208667 filed in Japan on Nov. 29, 2024, the entire content of which is hereby incorporated by reference.

### BACKGROUND

This disclosure relates to a force sensor device.

In recent years, electronic devices including a touch panel, such as smartphones and car navigation systems, have been prevailing. When a user operates an object such as an icon included in the displayed user interface through the touch panel, the electronic device activates the function associated with the object.

The surface of the touch panel is uniformly solid and therefore, the touch panel provides the same tactile sensation to the user's finger no matter which part of the touch panel is touched by the finger. For this reason, there is a known art to provide feedback that makes the user perceive the existence of an object or the acceptance of operation of an object together with activation of the function associated therewith. This art vibrates the touch panel in the in-plane direction of the touch panel to present tactile stimulus to the finger in contact with the touch panel.

The electronic devices utilizing this tactile presentation technology (tactile presentation device) can further include a force sensor. The force sensor includes a fixed beam that connects two components of the electronic device and a strain gauge attached on the beam. The electronic device detects movement of a component pressed by the user from the output of the strain gauge and presents tactile stimulus to the user's finger in response to the detected movement.

The force sensor device including a strain gauge attached on a fixed beam connecting two components is also included in various electronic devices other than the tactile presentation device with a touch panel as described above.

### SUMMARY

A force sensor device according to an aspect of this disclosure includes a first stage, a second stage disposed behind the first stage with a gap therebetween, a plurality of beams fixed to the second stage and the first stage, and strain gauges attached on the plurality of beams. The first stage is configured to move relatively to the second stage in response to a force applied from the front. The plurality of fixed beams are configured to deform with the movement of the first stage. Each of the plurality of beams includes a decreasing region where at least either the width or the thickness monotonically decreases from a first fixing point to one of the first stage and the second stage toward a second fixing point to the other one of the first stage and the second stage. Each strain gauge is attached within the decreasing region.

It is to be understood that both the foregoing general description and the following detailed description are exemplary and explanatory and are not restrictive of this disclosure.

### BRIEF DESCRIPTION OF THE DRAWINGS

FIG. 1 schematically illustrates a configuration example of a tactile presentation display device system in an embodiment of this disclosure.

FIG. 2A is a cross-sectional diagram schematically illustrating the structure of connection of a force sensor stage, a base stage, and a beam.

FIG. 2B is a cross-sectional diagram schematically illustrating deformation of the beam caused by depression of the force sensor stage.

FIG. 2C is a cross-sectional diagram schematically illustrating deformation of the beam caused by depression of the force sensor stage.

FIG. 3A is a perspective diagram of a configuration example of a force sensor device including beams in an embodiment of this disclosure when viewed from the back.

FIG. 3B is a perspective diagram of a beam component and its periphery when viewed from the back.

FIG. 3C is a plan diagram of the beam component and its periphery when viewed from the back.

FIG. 4A is a plan diagram of a beam component.

FIG. 4B is a perspective diagram illustrating the shape of a beam.

FIG. 5 provides specific examples of some dimensions of the beam.

FIG. 6 provides a result of a simulation where a force in the z-axis direction is applied to the load point.

FIG. 7 illustrates the shape of another beam used in a simulation with some specific dimensional values thereof.

FIG. 8 provides a result of the simulation where a force in the z-axis direction is applied to the load point.

FIG. 9 illustrates the shapes of three beams used in a simulation.

FIG. 10 provides simulation results when a force in the z-axis direction is applied to the load points of the three beams.

FIG. 11A is a plan diagram of another beam.

FIG. 11B is a perspective diagram illustrating the shape of the beam.

FIG. 12 provides specific examples of some dimensions of the beam.

FIG. 13 provides a result of a simulation where a force in the z-axis direction is applied to the load point.

FIG. 14A is a plan diagram of a beam in still another embodiment of this disclosure.

FIG. 14B provides a result of a simulation on the strain amount of the beam.

FIG. 15A is a plan diagram of a beam in still another embodiment of this disclosure.

FIG. 15B provides a result of a simulation on the strain amount of the beam.

FIG. 16 is a plan diagram of a beam in still another embodiment of this disclosure.

FIG. 17 is a plan diagram of a beam in still another embodiment of this disclosure.

FIG. 18 provides specific examples of some dimensions of the beams illustrated in FIGS. 16 and 17.

FIG. 19 provides results of a simulation where a force in the z-axis direction is applied to the load points of the two beams.

FIG. 20A is a perspective diagram of still another beam.

FIG. 20B is a cross-sectional diagram of the beam cut perpendicularly to the x-axis.

FIG. 21 provides dimensions of the beam used in a simulation.

FIG. 22 is a graph showing a result of the simulation.

FIG. 23 illustrates a configuration example for measuring a load with strain gauges.

FIG. 24 illustrates nine subregions obtained by dividing the display screen.

FIG. 25 provides a simulation result of cuboid beams.

FIG. 26 provides a simulation result of beams illustrated in FIG. 5.

FIG. 27 provides a simulation result of beams illustrated in FIG. 12.

FIG. 28A illustrates an example of the bonding layout of strain gauges on a beam.

FIG. 28B illustrates another example of the bonding layout of strain gauges on a beam.

FIG. 28C illustrates still another example of the bonding layout of strain gauges on a beam.

FIG. 28D illustrates still another example of the bonding layout of strain gauges on a beam.

FIG. 29 illustrates a configuration example of a Wheatstone bridge circuit.

FIG. 30 illustrates a configuration example of a force sensor device including two Wheatstone bridge circuits.

FIG. 31 illustrates a configuration example of a force sensor device including four Wheatstone bridge circuits.

### EMBODIMENTS

Hereinafter, embodiments of this disclosure are described with reference to the accompanying drawings. It should be noted that the embodiments are merely examples to implement the disclosure and they are not to limit the technical scope of the disclosure.

An embodiment of this disclosure discloses a force sensor device. The force sensor can be used in various electronic devices. As an example of such electronic devices, a tactile presentation display device is described in the following. The tactile presentation display device includes a display device having a touch sensing function and a tactile presentation device that provides tactile stimulus to a finger touching the touch surface of the display device.

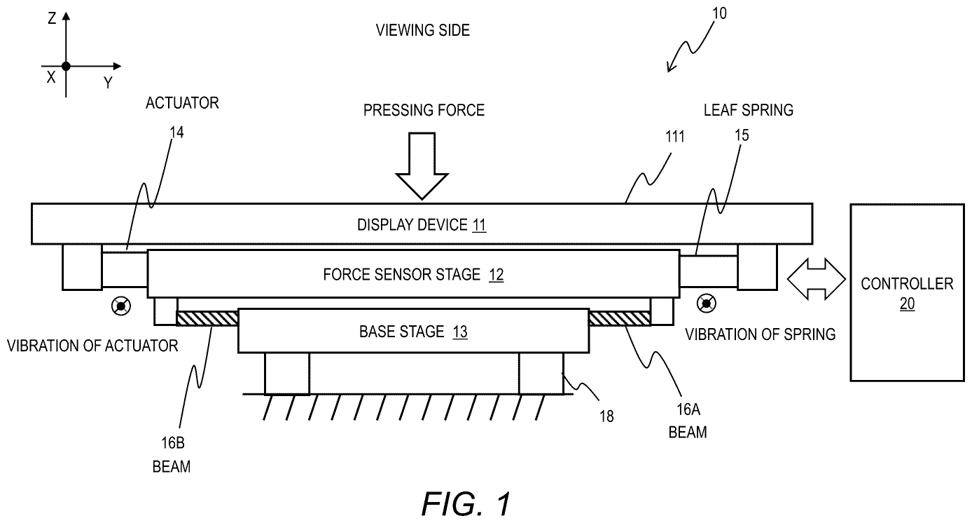

FIG. 1 schematically illustrates a configuration example of a tactile presentation display device system in an embodiment of this disclosure as an example of the electronic device including the force sensor device of this disclosure. The tactile presentation display device system includes a tactile presentation display device 10 and a controller 20 for controlling the tactile presentation display device 10.

The tactile presentation display device system presents a user interface (UI) including at least one object to the user and accepts the user's operation through the UI. The tactile presentation display device system also provides feedback to make the user perceive the objects included in the UI and feedback to notify the user of acceptance of the user's operation of an object.

FIG. 1 schematically illustrates the cross-sectional structure of the tactile presentation display device 10. The controller 20 therein represents a function block and does not illustrate its physical structure. The tactile presentation display device 10 includes a display device 11, a force sensor stage (first stage) 12, and a base stage (second stage) 13 laid one above another. In the following description, the side where the user to view the displayed image is located is defined as front and the opposite side as back. In FIG. 1, the display device 11 is located in front of the force sensor stage 12 and the base stage 13 is located behind the force sensor stage 12.

In FIG. 1, the front-back direction or the layering direction is the z-axis direction and the x-axis direction (second direction) and the y-axis direction (first direction) are in-plane directions of the display device 11, the force sensor stage 12, or the base stage 13. The x-axis, y-axis, and z-axis are perpendicular to one another.

The display device 11 can be a display device with a touch sensor. The display device 11 can include a touch panel having a touch surface 111 and a display module behind it. The display module can be an organic light-emitting diode (OLED) display module, a micro-LED display module, or a liquid crystal display module, for example. The liquid crystal display module can include a liquid crystal panel and a backlight unit behind it.

The touch surface 111 and the back surface are the main faces of the display device 11. The touch surface 111 is also an image display surface to display images for the user. An example of the display device 11 has a quadrangular shape but the display device 11 can have any shape. The touch sensor function of the display device 11 is optional.

The force sensor stage 12 is disposed behind the display device 11 with a gap therebetween. The force sensor stage 12 is connected to the back face of the display device 11 via an actuator 14 and a leaf spring 15. In other words, the display device 11 is supported by the actuator 14 and the leaf spring 15 fixed to the force sensor stage 12.

The actuator 14 is a lateral actuator; it is a device for generating movement in the directions parallel to the image display surface. The display device 11 vibrates in the x-axis direction because of the movement of the actuator 14. The leaf spring 15 is mounted in such an orientation that it deforms elastically in the x-axis direction and does not deform elastically in the z-axis direction. As a result of this disposition, the leaf spring 15 supports the display device 11 elastically in the x-axis direction and vibrates in the x-axis direction with vibration of the display device 11 caused by movement of the actuator 14. The leaf spring 15 is used as a mechanism to generate vibration in accordance with the movement of the actuator 14. The number and the layout of actuators 14 and leaf springs 15 are not limited specifically and they are determined appropriately depending on the design.

The base stage 13 is placed on the mounting surface with dampers 18 interposed therebetween. In FIG. 1, one of the dampers is provided with a reference numeral 18 by way of example. The base stage 13 can be fixed or not to the mounting surface. When the tactile presentation display device 10 is in operation, the base stage 13 is stationary on the mounting surface.

The force sensor stage 12 is disposed between the base stage 13 and the display device 11. The force sensor stage 12 is disposed in front of the base stage 13 with a gap therebetween. The back face of the force sensor stage 12 is connected to the base stage 13 via two beams 16A and 16B. Each of the beams 16A and 16B is fixed to the base stage 13 and the force sensor stage 12.

A not-shown strain gauge is bonded on each of the beams 16A and 16B. The display device 11 is lowered in the z-axis direction by the user's pressing force to the display device 11. Since the leaf spring 15 does not deform in the z-axis direction, the display device 11 and the force sensor stage 12 are integrally lowered without reducing the gap therebetween. The force sensor stage 12 is pushed toward the base stage 13 by the pressing force from the display device 11.

That is to say, the force sensor stage 12 moves backward to get closer to the base stage 13. In response to the positional change of the force sensor stage 12 relative to the base stage 13, the fixed beams 16A and 16B deform. The strain gauges output values in accordance with the deformation amounts of the fixed beams 16A and 16B to the controller 20. In this way, the force applied by the user's finger perpendicularly to the display screen (touch surface) can be measured based on the outputs from the strain gauges bonded on the fixed beams 16A and 16B.

The force sensor stage 12, the base stage 13, and the beams 16A and 16B are included in the force sensor device. Although FIG. 1 shows two beams 16A and 16B, the number and the disposition of beams are determined appropriately depending on the design.

In an example, the controller 20 detects a contact of a user's finger to the touch surface (display screen) based on the output from the display device 11 including a touch sensor and locates the user's finger on the display screen. The controller 20 detects that the user has pressed a displayed object based on the output values of the strain gauges, the position of the user's finger on the display screen, and predetermined information. For example, the controller 20 determines that an object pressing event has occurred when a specific region of the display device 11 is touched and the value of the force calculated from the output values of the strain gauges is larger than a threshold value.

Upon detection of an object pressing event, the controller 20 controls the movement of the actuator 14 to generate mechanical vibration of the display device 11 so that the user will perceive that the operation of the object is accepted. For example, the controller 20 applies a driving pulse to the actuator 14 to provide a tactile click to the user's finger.

An example of the driving pulse consists of a first pulse and a second pulse having the same voltage magnitude. The actuator 14 makes the touch surface shift in one direction from the initial position in response to application of the first pulse and shift in the opposite direction to start reciprocal motion in response to stop of the application of the first pulse. After a predetermined time of no application, the controller 20 applies the second pulse to make the touch surface stop shifting at the initial position.

FIG. 1 illustrates one configuration example of the tactile presentation display device 10 of this disclosure; the tactile presentation display device 10 can have different configurations. For example, the actuator 14 and the leaf spring 15 can connect the base stage 13 and the force sensor stage 12 and the beams 16A and 16B with strain gauges can connect the force sensor stage 12 and the display device 11.

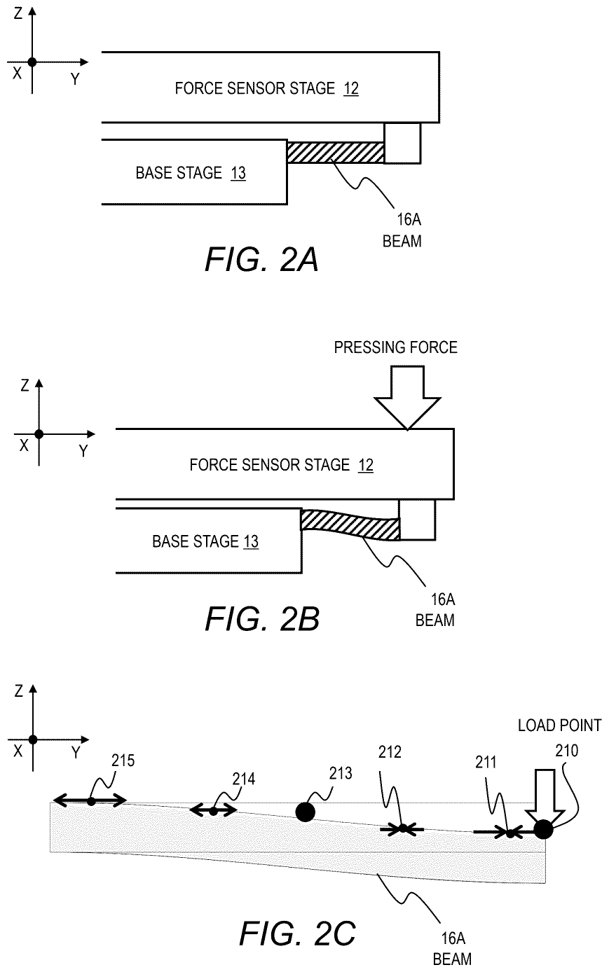

FIGS. 2A to 2C are cross-sectional diagrams schematically illustrating deformation of the fixed beam 16A caused by depression of the force sensor stage 12. The fixed beam 16B also deforms like the fixed beam 16A. FIG. 2A illustrates the shape of the beam 16A in the initial state and FIG. 2B illustrates the shape of the beam 16A when the force sensor stage 12 is depressed.

FIG. 2C illustrates the strains at different points of the beam 16A when the force sensor stage 12 is depressed. In FIG. 2C, the load point 210 is the connection point (fixing point) of the beam 16A to the force sensor stage 12. The direction of straining is the y-axis direction. Assume that the base-stage-side end of the beam 16A is restrained in the x-axis, y-axis, and z-axis directions and the opposite end (force-sensor-stage-side end) is restrained in the x-axis and y-axis directions.

At a point 211 close to the load point 210, the fixed beam 16A contracts. At the midpoint 213, no strain occurs. The contraction amount (strain amount) decreases from the load point 210 (the force-sensor-stage-side end) to the midpoint 213. For example, the contraction amount at the point 211 close to the load point 210 is larger than the one at a point 212 close to the midpoint 213.

The fixed beam 16A extends in the y-axis direction at the base-stage-side end. The extension amount increases from the midpoint 213 to the base-stage-side end. For example, the extension amount at a point 215 close to the base-stage-side end is larger than the one at a point 214 close to the midpoint 213.

As understood from the above, the magnitude and the direction along the y-axis of the strain of the fixed beam 16A can be different depending on the position on the y-axis. For this reason, if the bonding points of the strain gauges are different among products, the output values of the strain gauges will have variations among the products. Variations in the output values of the strain gauges hamper accurate detection of depression of the force sensor stage 12.

An embodiment of this disclosure employs a specific shape and a specific strain gauge attachment point for a beam to reduce the variations in the output values of strain gauges caused by variations in the strain gauge attachment points. Hereinafter, the shape of the beam and the bonding point of the strain gauge to the beam in an embodiment of this disclosure are described.

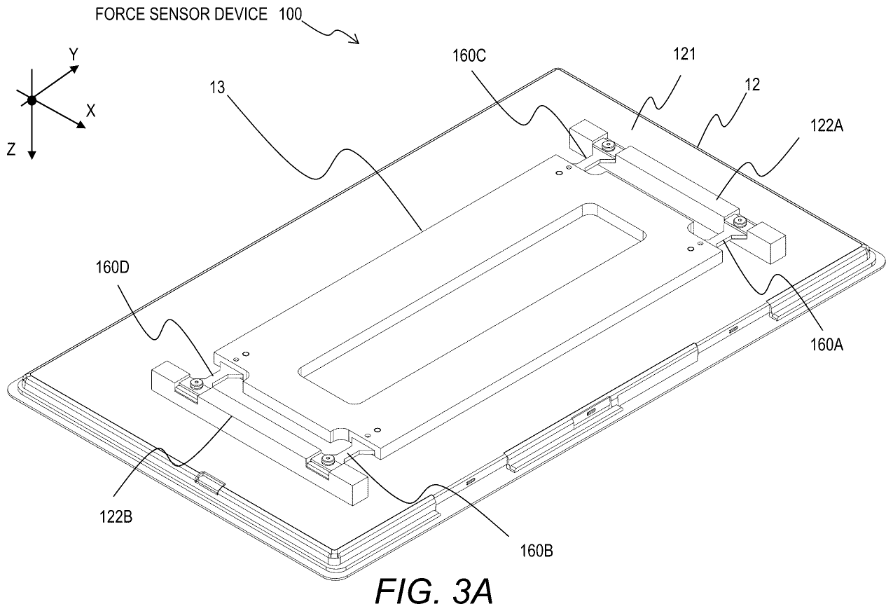

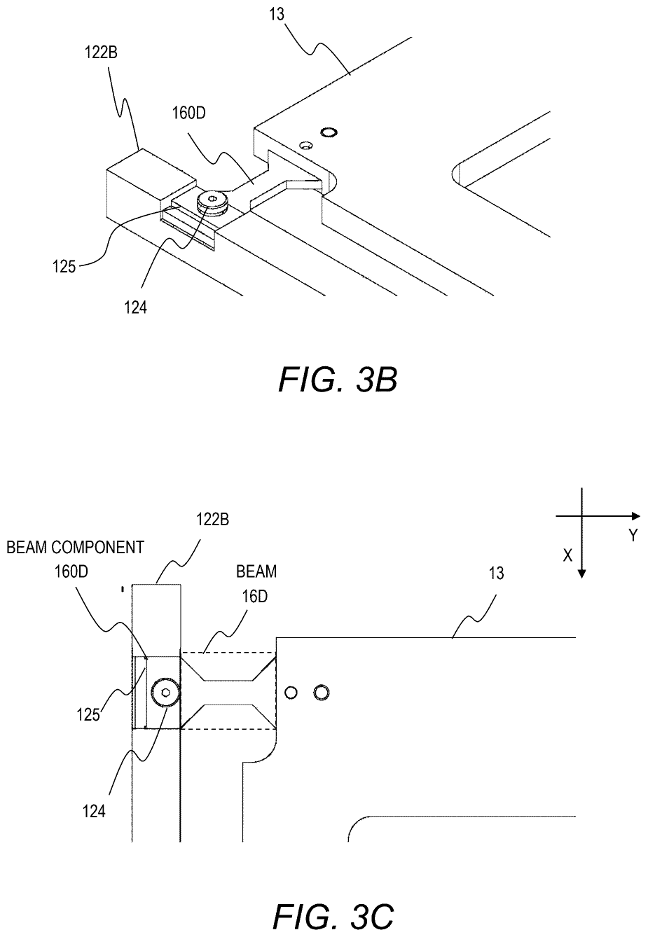

FIG. 3A is a perspective diagram of a configuration example of the force sensor device 100 including beams in an embodiment of this disclosure when viewed from the back. The force sensor device 100 includes a force sensor stage 12 and a base stage 13. The force sensor device 100 further includes beam components 160A to 160D connecting the force sensor stage 12 and the base stage 13. As will be described later, the middle parts of the beam components 160A to 160D correspond to the beams.

The force sensor stage 12 is a rectangular plate-like component and can be made of metal or resin. The force sensor stage 12 can have any shape and the shape is not limited specifically. The force sensor stage 12 includes prismatic supports 122A and 122B on its back face 121. The supports 122A and 122B are disposed to be distant from each other in the y-axis direction and each of them extends along the x-axis.

The base stage 13 is a rectangular plate-like component having an opening in the center and can be made of metal or resin. The base stage 13 can have any shape and the shape is not limited specifically. As described with reference to FIG. 1, there is a gap between the base stage 13 (the front face thereof) and the back face 121 of the force sensor stage 12 in the normal state.

In the configuration example of FIG. 3A, the base stage 13 is disposed in the region sandwiched by the supports 122A and 122B. Each of the four beam components 160A to 160D is fixed to the force sensor stage 12 at one end and also to the base stage 13 at the other end. The beam components 160A and 160C are fixed to the back face of the support 122A at their one ends and to the front face of the base stage 13 at their other ends. The beam components 160B and 160D are fixed to the back face of the support 122B at their one ends and to the front face of the base stage 13 at their other ends.

The beam components 160A and 160C are fixed to one side of the base stage 13 and the beam components 160B and 160D are fixed to the opposite side of the base stage 13. The beam components 160A to 160D are disposed symmetrically with respect to the x-axis and the y-axis (axes of symmetry). The number and the mounting positions of beam components are not limited to this example; appropriate number and positions are selected in accordance with the design.

FIGS. 3B and 3C are a perspective diagram and a plan diagram, respectively, of the beam component 160D and its periphery when viewed from the back. The beam components 160A to 160D have the identical shapes; the description of the beam component 160D is applicable to the beam components 160A to 160C. The beam component 160D is fixed to the support 122B with a screw 124. A rectangular washer 125 is provided between the screw 124 and the beam component 160D. The beam component 160D can also be fixed to the front face of the base stage 13 with a washer and a screw in the same way. The beam component 160D can be fixed to the force sensor stage 12 and the base stage 13 by other structures; the fixation structures to the force sensor stage 12 and the base stage 13 can be the same or different.

With reference to FIG. 3C, the part of the beam component 160D in the region surrounded by the dashed line is a beam 16D. The beam 16D is a region that is not in contact with or fixed to either the force sensor stage 12 or the base stage 13; it is a free region not restrained in any of the x-axis, y-axis, and z-axis directions. The force-sensor-stage side end and the base-stage-side end of the beam 16D are linear load regions. Although the base-stage-side end is fixed, it is a relative load region.

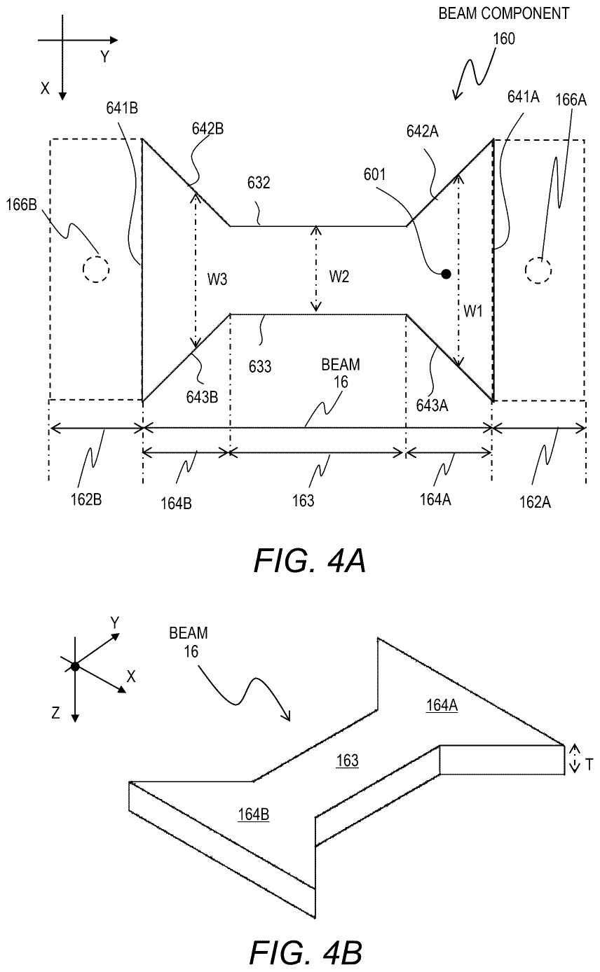

FIG. 4A is a plan diagram of a beam component 160. The beam components 160A to 160D have a shape identical to the beam component 160. The beam component 160 consists of a plurality of regions; each solid line with arrows indicates a region of the beam component 160. The beam component 160 consists of fixture regions 162A and 162B and a region of a beam 16 therebetween. The fixture regions 162A and 162B are the rectangular regions surrounded by dashed lines and they respectively have holes 166A and 166B for a screw to extend therethrough. The beam component 160 has a line-symmetric shape about the x-axis and the y-axis.

In an example, the fixture region 162A is fixed to the force sensor stage 12 and the fixture region 162B is fixed to the base stage 13. As described with reference to FIGS. 3B and 3C, the fixture regions 162A and 162B are in contact with the faces of the force sensor stage 12 and the base stage 13 to be pressed and fixed by a screw and a rectangular washer. The beam 16 is away from the other components, including the force sensor stage 12 and the base stage 13.

As described with reference to FIGS. 2A to 2C, when the force sensor stage 12 is depressed toward the base stage 13, the beam 16 deforms in a large amount in the z-axis direction. Furthermore, the beam 16 strains in the y-axis direction. This embodiment measures the depression of the force sensor stage 12 by measuring the strain in the y-axis direction.

The strain of the beam 16 is measured with a strain gauge bonded on the surface of the beam 16. As described with reference to FIG. 2C, the strain amount of the beam 16 can be different depending on the position on the y-axis. To reduce the variations in measured strain amounts among products, it is preferable to bond the strain gauge to the region where the variation in strain amount depending on the position on the y-axis is small.

The beam 16 consists of three regions 164A, 163, and 164B lying side by side along the y-axis. The region 163 is sandwiched by the regions 164A and 164B. The region 164A is a decreasing region where its width W1 decreases with the distance from the load region. The width W1 is the dimension along the x-axis. The side (distal end) 641A of the region 164A is the load region. The side 641A is the boundary between the region 164A and the fixture region 162A.

The width W1 of the region 164A monotonically decreases from the side 641A toward the center of the beam 16 along the y-axis. In the example of the shape illustrated in FIG. 4A, the sides 642A and 643A defining the width of the region 164A are straight. The shape of the region 164A is line-symmetric about the y-axis.

The region 164B is another decreasing region where its width W3 decreases with the distance from the load region. The width W3 is the dimension along the x-axis. The side (distal end) 641B of the region 164B is the load region. The side 641B is the boundary between the region 164B and the fixture region 162B.

The width W3 of the region 164B monotonically decreases from the side 641B toward the center of the beam 16 along the y-axis. In the example of the shape illustrated in FIG. 4A, the sides 642B and 643B defining the width of the region 164B are straight. The shape of the region 164B is line-symmetric about the y-axis. The shapes of the regions 164B and 164A are line-symmetric about the x-axis.

The mid-region 163 sandwiched by the width decreasing regions 164A and 164B has a uniform width W2. The opposite sides 632 and 633 defining the width W2 are parallel to the y-axis. The width W2 takes a value equal to the minimum values of the widths W1 and W3 of the regions 164A and 164B. The mid-region 163 can be optional.

An embodiment of this disclosure disposes the strain gauge in the width decreasing region. As a result, the variations in the output values of strain gauges caused by variations in their bonding points on the y-axis can be reduced. Moreover, the decreasing region illustrated in FIG. 4A has a symmetric shape about the y-axis. As a result, the variations in the output values of strain gauges caused by variations in their bonding points on the x-axis can be reduced.

For example, at least the centroid of the strain gauge is located in the width decreasing region. Moreover, the entire strain gauge can be included in the width decreasing region. The bonding point 601 in FIG. 4A indicates the centroid of the bonded strain gauge. The bonding point 601 can be located at the midpoint on the x-axis. That is to say, the distances from the bonding point 601 to the intersections of the virtual line extending along the x-axis and passing through the bonding point 601 with the sides 642A and 643A can be equal. The bonding point 601 can be located at a point different from the midpoint on the x-axis.

FIG. 4B is a perspective diagram illustrating the shape of the beam 16. The beam component 160 has a thin plate-like shape. The thickness T of the beam component 160 is uniform and the thickness T of the beam 16 is also uniform. The cross-sections perpendicular to the direction of the thickness of the beam 16 (the z-axis direction) are identical. In other words, all the side faces of the beam 16 are parallel to the z-axis.

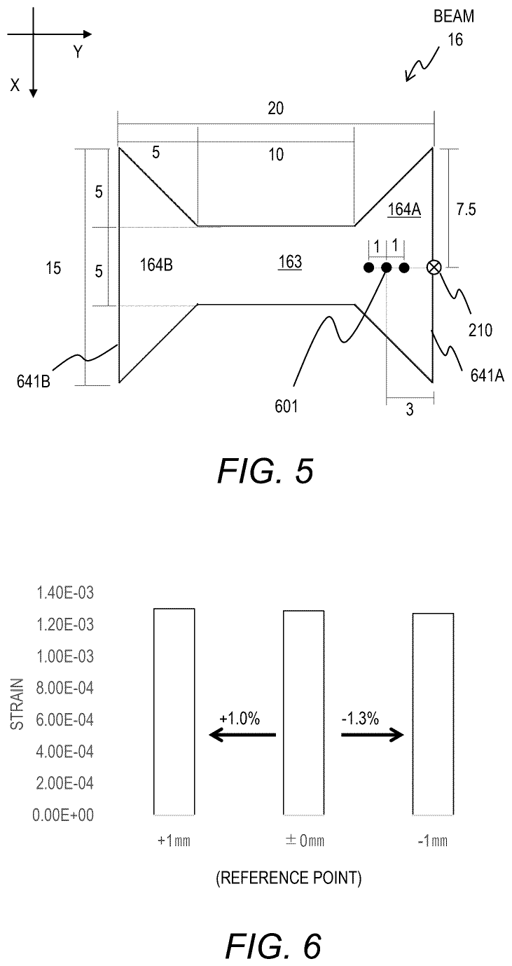

The effect of the width decreasing region to reduce the variations in strain is described. FIG. 5 provides specific examples of some dimensions of the beam 16. The unit of the numerical values is millimeters. Assume that the beam 16 is made of stainless steel and has a thickness of 2 mm, the load point 210 is a point on the side 641A, the side 641A is restrained in the x-axis direction and the y-axis direction, and the opposite side 641B is restrained in the x-axis direction, the y-axis direction, and the z-axis direction.

The bonding point 601 is the reference bonding point of the strain gauge. The strain gauge is disposed in the width decreasing region 164A. The points on both sides of the reference bonding point 601 are bonding points located 1 mm left and right from the reference point 601.

FIG. 6 provides a result of a simulation where a force of 175 N in the z-axis direction is applied to the load point 210. In the graph of FIG. 6, the horizontal axis indicates the distance in the y-axis direction from the reference bonding point 601 on the beam 16. The vertical axis indicates the amount of strain along the y-axis. With reference to FIG. 6, the strains at the points located 1 mm left and right from the reference bonding point 601 are different from the strain at the reference bonding point 601 by 1% and −1.3%, respectively.

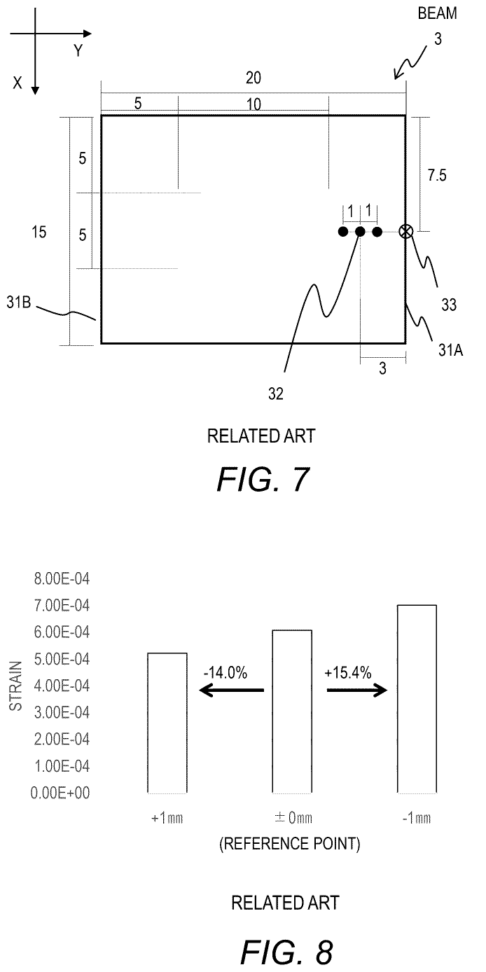

FIGS. 7 and 8 provide a simulation result on a rectangular (cuboid) beam. FIG. 7 illustrates the shape of a beam 3 used in the simulation with some specific dimensional values. The unit of the numerical values is millimeters. The beam 3 is made of stainless steel and has a thickness of 2 mm. The load point 33 is a point on a side (distal end) 31A restrained in the x-axis direction and the y-axis direction. The opposite side (distal end) 31B is restrained in the x-axis direction, the y-axis direction, and the z-axis direction.

The bonding point 32 is the reference bonding point of the strain gauge. The

points on both sides of the reference bonding point 32 are bonding points located 1 mm left and right from the reference bonding point 32. FIG. 8 provides a result of the simulation where a force of 175 N in the z-axis direction is applied to the load point 33. In the graph of FIG. 8, the horizontal axis indicates the distance in the y-axis direction from the reference bonding point 32 on the beam 3. The vertical axis indicates the amount of strain along the y-axis. With reference to FIG. 8, the strains at the points located 1 mm left and right from the reference bonding point 32 are different from the strain at the reference bonding point 32 by −14.0% and 15.4%, respectively.

The comparison of the simulation results in FIGS. 6 and 8 indicates that the width decreasing region of the beam 16 significantly reduces the difference in strain amount caused by the positional difference. In other words, the simulation results indicate that the width decreasing region significantly reduces the variations in measured values caused by variations in the bonding points of strain gauges.

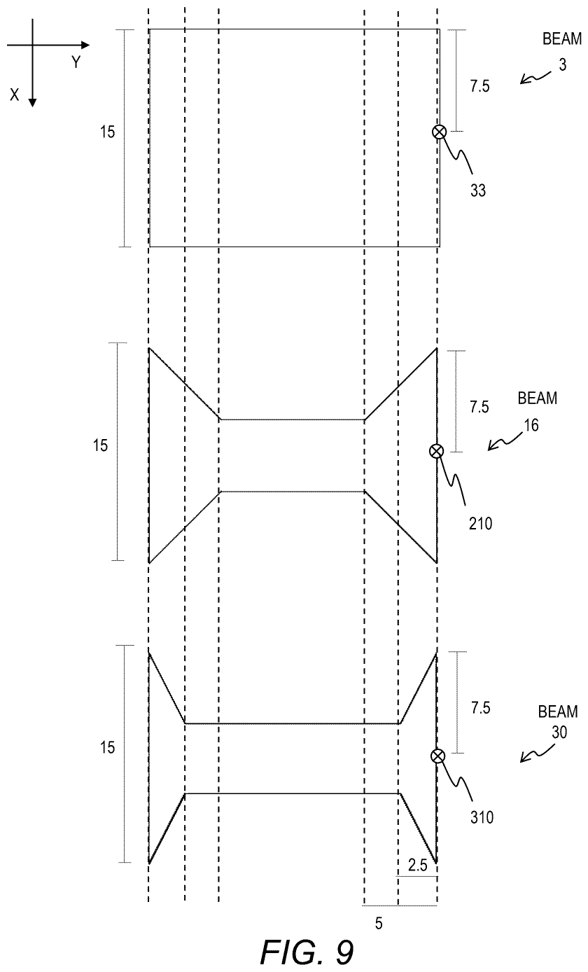

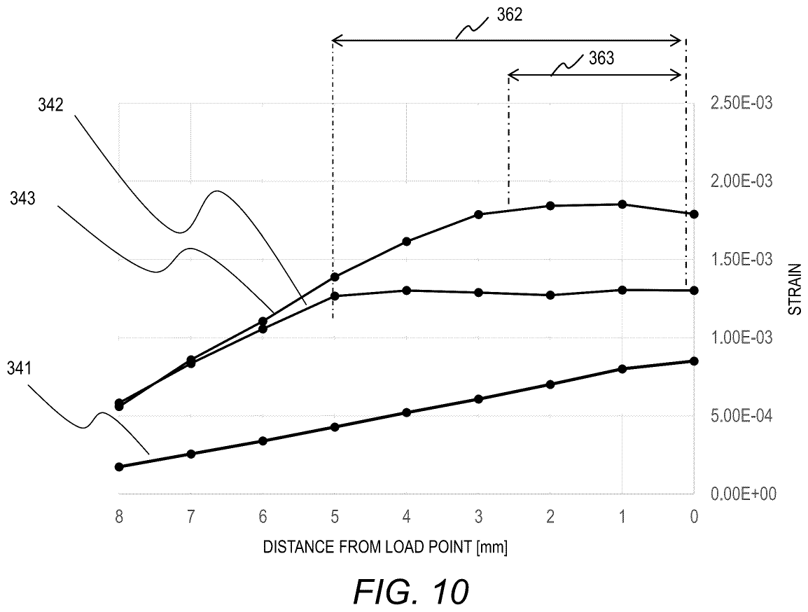

FIGS. 9 and 10 provide simulation results on a plurality of beams. FIG. 9 illustrates the shapes of three beams 3, 16, and 30 used in the simulation. The beam 3 has the same shape as the beam 3 illustrated in FIG. 7; the beam 16 has the same shape as the beam 16 illustrated in FIG. 5.

The beam 30 has a shape different from the beam 16 in the length (the dimension along the y-axis) of the left and right width decreasing regions. Except for the differences in other dimensions caused by the difference in the length of the left and right width decreasing regions, the shape of the beam 30 is the same as that of the beam 16. The unit of the numerical values indicating some dimensions shown in FIG. 9 is millimeters. The beams 3, 16, and 30 have a thickness of 2 mm and they are made of stainless steel.

FIG. 10 provides simulation results when a force of 175 N in the z-axis direction is applied to the load points 33, 210, and 310 of the beams 3, 16, and 30. In the graph of FIG. 10, the horizontal axis indicates the distance from the load point and the vertical axis indicates the amount of strain of the beam along the y-axis. The curve 341 represents the simulation result on the beam 3; the curve 342 represents the simulation result on the beam 16; and the curve 343 represents the simulation result on the beam 30. The line with arrows 362 indicates the width decreasing region of the beam 16 and the line with arrows 363 indicates the width decreasing region of the beam 30.

The simulation result 341 on the beam 3 indicates that the strain amount gradually decreases with the distance from the load point 33. The simulation result 342 on the beam 16 indicates that the variation in strain amount within the width decreasing region 362 is significantly small, compared to that of the beam 3. The simulation result 343 on the beam 30 indicates that the variation in strain amount within the width decreasing region 363 is significantly small, compared to that of the beam 3. As noted from these results, the width decreasing region can effectively decrease the variation in strain amount depending on the position.

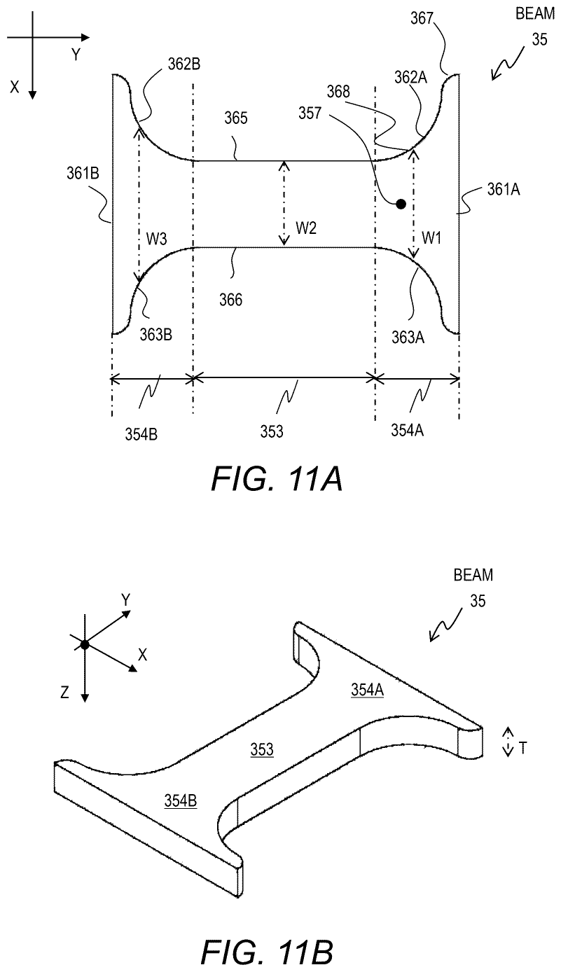

Hereinafter, some beams having different shapes in other embodiments of this disclosure are described. The beams described in the following are applicable to the above-described beam component having fixture regions. FIG. 11A is a plan diagram of a beam 35. The beam 35 consists of a plurality of regions; each line with arrows indicates a region of the beam 35. The beam 35 consists of three regions 354A, 353, and 354B lying side by side along the y-axis. The region 353 is sandwiched by the regions 354A and 354B. The region 354A is a decreasing region where its width W1 decreases with the distance from the load region. The width W1 is the dimension along the x-axis. The side (distal end) 361A of the region 354A is the load region. The side 361A is the boundary between the region 354A and a not-shown fixture region.

The width W1 of the region 354A monotonically decreases from the side 361A toward the center of the beam 35 along the y-axis. In the example of the shape illustrated in FIG. 11A, the sides 362A and 363A defining the width of the region 354A are curved. The shape of the region 354A is line-symmetric about the y-axis.

Each of the sides 362A and 363A consists of two curves. Specifically, it consists of a convex (outward bulging) curve 367 from the side 361A toward the center and a concave curve 368 continued from the curve 367. FIG. 11A provides the reference numerals 367 and 368 only for the side 362A by way of example. For example, the curve 367 is a 90-degree arc and the curve 368 is a 90-degree arc having a larger curvature radius than the curve 367.

The region 354B is another decreasing region where its width W3 decreases with the distance from the load region. The width W3 is the dimension along the x-axis. The side (distal end) 361B of the region 354B is the load region. The side 361B is the boundary between the region 354B and a not-shown fixture region.

The width W3 of the region 354B monotonically decreases from the side 361B toward the center of the beam 35 along the y-axis. In the example of the shape illustrated in FIG. 11A, the sides 362B and 363B defining the width of the region 354B are curved. The shape of the region 354B is line-symmetric about the y-axis. The shapes of the regions 354B and 354A are line-symmetric about the x-axis.

The mid-region 353 sandwiched by the width decreasing regions 354A and 354B has a uniform width W2. The opposite sides 365 and 366 defining the width W2 are parallel to the y-axis. The width W2 takes a value equal to the minimum values of the widths W1 and W3 of the regions 354A and 354B.

The bonding point 357 of the strain gauge in FIG. 11A indicates the centroid of the bonded strain gauge. The bonding point 357 is located within the width decreasing region 354A. The bonding point 357 can be located at the midpoint on the x-axis or a point different from the midpoint on the x-axis.

FIG. 11B is a perspective diagram illustrating the shape of the beam 35. The thickness T of the beam 35 is uniform. The cross-sections perpendicular to the direction of the thickness of the beam 35 (the z-axis direction) are identical.

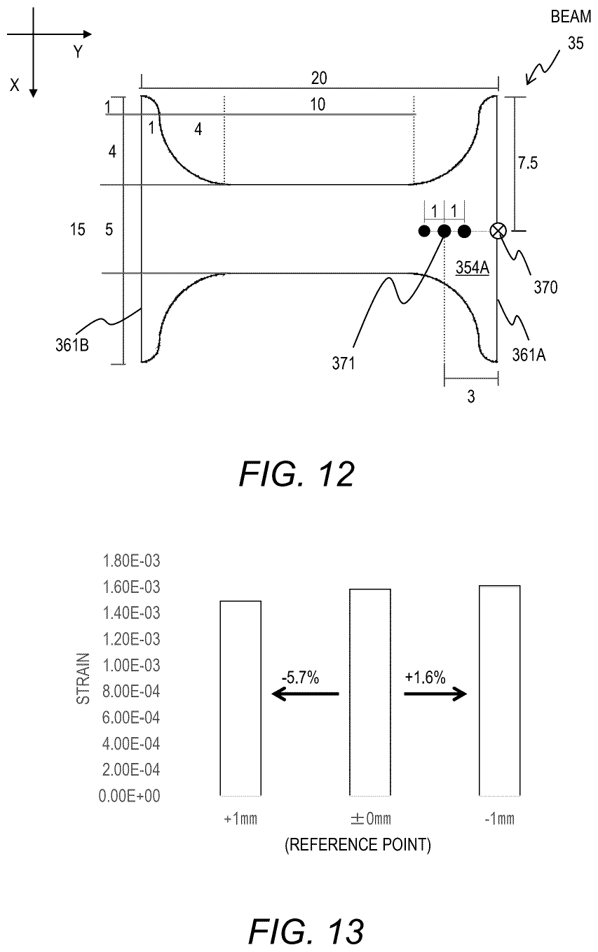

The effect of the width decreasing region of the beam 35 to reduce the variations in strain is described. FIG. 12 provides specific examples of some dimensions of the beam 35. The unit of the numerical values is millimeters. Assume that the beam 35 is made of stainless steel and has a thickness of 2 mm, the load point 370 is a point on the side 361A, the side 361A is restrained in the x-axis direction and the y-axis direction, and the opposite side 361B is restrained in the x-axis direction, the y-axis direction, and the z-axis direction.

The bonding point 371 is the reference bonding point of the strain gauge. The strain gauge is disposed in the width decreasing region 354A. The points on both sides of the reference bonding point 371 are bonding points located 1 mm left and right from the reference bonding point 371.

FIG. 13 provides a result of a simulation where a force of 175 N in the z-axis direction is applied to the load point 370. In the graph of FIG. 13, the horizontal axis indicates the distance in the y-axis direction from the reference bonding point 371 on the beam 35. The vertical axis indicates the amount of strain along the y-axis. The strains at the points located 1 mm left and right from the reference bonding point 371 are different from the strain at the reference bonding point 371 by −5.7% and 1.6%, respectively. These differences are significantly improved, compared to those of the rectangular beam 3 described with reference to FIGS. 7 and 8.

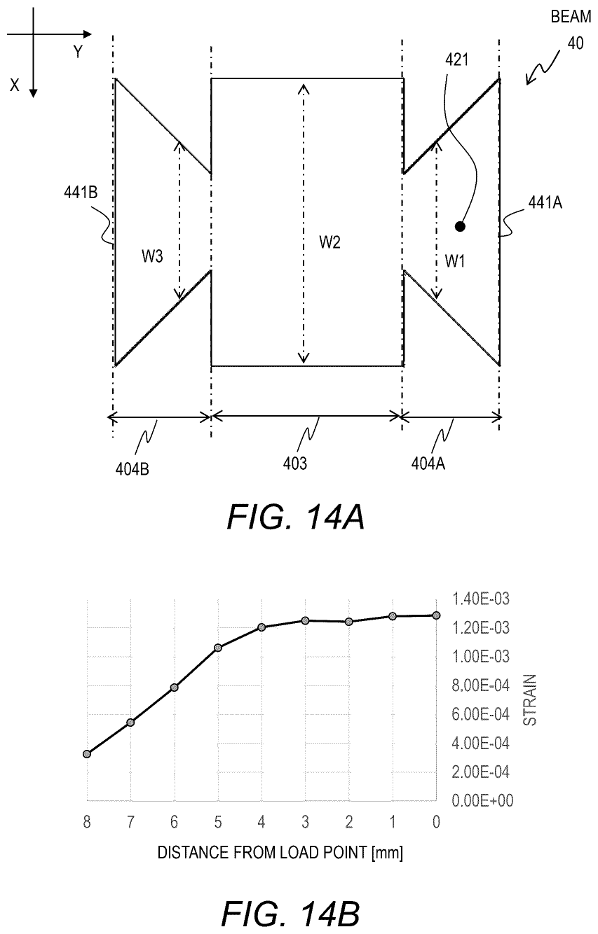

FIG. 14A is a plan diagram of a beam 40 in still another embodiment of this disclosure. The beam 40 consists of three regions 404A, 403, and 404B lying side by side along the y-axis. The region 403 is sandwiched by the regions 404A and 404B. The region 404A is a decreasing region where its width W1 decreases with the distance from the side (distal end) 441A of the load region.

The width W1 of the region 404A monotonically decreases from the side 441A of the load region toward the center of the beam 40 along the y-axis. The sides defining the width of the region 404A are straight. The shape of the region 404A is line-symmetric about the y-axis.

The region 404B is another decreasing region where its width W3 decreases with the distance from the side (distal end) 441B of the load region. The width W3 of the region 404B monotonically decreases from the side 441B toward the center of the beam 40 along the y-axis. The sides defining the width of the region 404B are straight. The shape of the region 404B is line-symmetric about the y-axis. The shapes of the regions 404B and 404A are line-symmetric about the x-axis.

The mid-region 403 sandwiched by the width decreasing regions 404A and 404B has a uniform width W2. The opposite sides defining the width W2 are parallel to the y-axis. The width W2 takes a value equal to the maximum values of the widths W1 and W3 of the regions 404A and 404B.

The bonding point 421 of the strain gauge in FIG. 14A indicates the centroid of the bonded strain gauge. The bonding point 421 is located within the width decreasing region 404A. The bonding point 421 can be located at the midpoint on the x-axis or a point different from the midpoint on the x-axis.

FIG. 14B provides a result of a simulation on the strain amount of the beam 40. In the beam 40 used in the simulation, the width W2 and the maximum values of the widths W1 and W3 are 15 mm, the minimum values of the widths W1 and W3 are 5 mm, the lengths (the dimensions along the y-axis) of the regions 404A and 404B are 5 mm, the length (the dimension along the y-axis) of the region 403 is 10 mm, and the thickness is 2 mm. The material of the beam 40 is stainless steel. The load point is located at the midpoint of the side 441A. As noted from FIG. 14B, the variation in strain amount is significantly small in the width decreasing region 404A, particularly within the region of 4 mm from the load point.

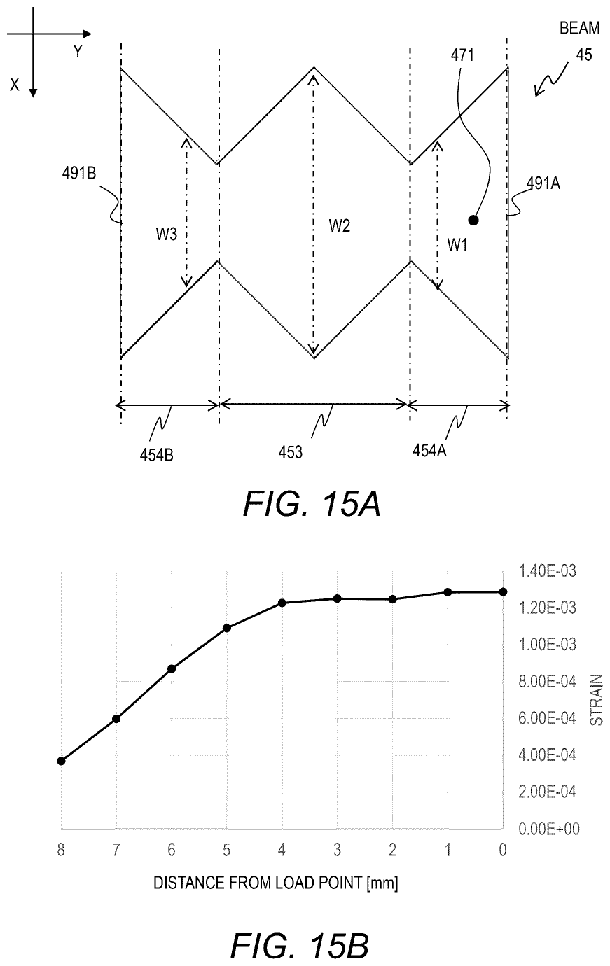

FIG. 15A is a plan diagram of a beam 45 in still another embodiment of this disclosure. The beam 45 consists of three regions 454A, 453, and 454B lying side by side along the y-axis. The region 453 is sandwiched by the regions 454A and 454B. The region 454A is a decreasing region where its width W1 decreases with the distance from the side (distal end) 491A of the load region.

The width W1 of the region 454A monotonically decreases from the side 491A of the load region toward the center of the beam 45 along the y-axis. The sides defining the width of the region 454A are straight. The shape of the region 454A is line-symmetric about the y-axis.

The region 454B is another decreasing region where its width W3 decreases with the distance from the side (distal end) 491B of the load region. The width W3 of the region 454B monotonically decreases from the side 491B toward the center of the beam 45 along the y-axis. The sides defining the width of the region 454B are straight. The shape of the region 454B is line-symmetric about the y-axis. The shapes of the regions 454B and 454A are line-symmetric about the x-axis.

The mid-region 453 sandwiched by the width decreasing regions 454A and 454B has a width W2 varying with the position on the y-axis. Specifically, the width W2 monotonically increases from the boundary with the width decreasing region 454A toward the center of the region 453 along the y-axis. The width W2 of the mid-region 453 takes the same minimum value as the width W1 of the width decreasing region 454A at their boundary. The width W2 of the mid-region 453 also takes the same minimum value as the width W3 of the width decreasing region 454B at their boundary. The maximum value of the width W2 of the mid-region 453 is equal to the maximum values of the widths W1 and W3.

The bonding point 471 of the strain gauge in FIG. 15A indicates the centroid of the bonded strain gauge. The bonding point 471 is located within the width decreasing region 454A. The bonding point 471 can be the midpoint on the x-axis or a point different from the midpoint on the x-axis.

FIG. 15B provides a result of a simulation on the strain amount of the beam 45. In the beam 45 used in the simulation, the maximum values of the widths W1, W2, and W3 are 15 mm, the minimum values of the widths W1, W2, and W3 are 5 mm, the lengths (the dimensions along the y-axis) of the regions 454A and 454B are 5 mm, the length (the dimension along the y-axis) of the region 453 is 10 mm, and the thickness is 2 mm. The material of the beam 45 is stainless steel. The load point is located at the midpoint of the side 491A. As noted from FIG. 15B, the variation in strain amount is significantly small in the width decreasing region 454A, particularly within the region of 4 mm from the load point.

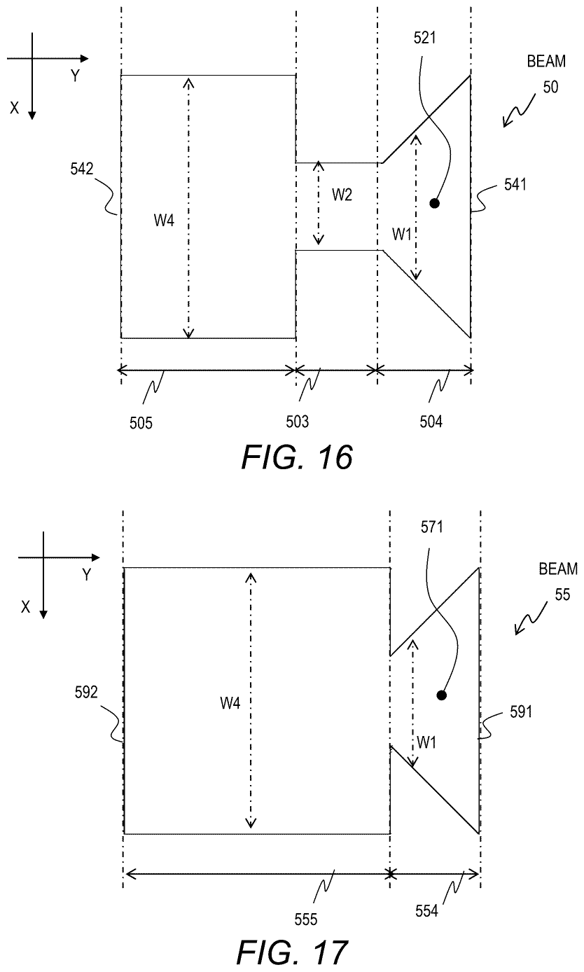

FIG. 16 is a plan diagram of a beam 50 in still another embodiment of this disclosure. The beam 50 consists of three regions 504, 503, and 505 lying side by side along the y-axis. The region 503 is sandwiched by the regions 504 and 505. The region 504 is a decreasing region where its width W1 decreases with the distance from the side (distal end) 541 of the load region.

The width W1 of the region 504 monotonically decreases from the side 541 of the load region toward the center of the beam 50 along the y-axis. The sides defining the width of the region 504 are straight. The shape of the region 504 is line-symmetric about the y-axis.

The region 505 is a non-decreasing region where its width W4 is uniform. The width W4 takes the maximum value of the width W1 of the region 504. The side (distal end) 542 is a load region. The sides defining the width W4 of the region 505 are straight and parallel to the y-axis. The shape of the region 505 is a rectangle and it is line-symmetric about the y-axis.

The mid-region 503 has a uniform width W2. The opposite sides defining the width W2 are parallel to the y-axis. The width W2 takes the same value as the minimum value of the width W1 of the region 504 and it is narrower than the width W4 of the region 505.

The bonding point 521 of the strain gauge in FIG. 16 indicates the centroid of the bonded strain gauge. The bonding point 521 is located within the width decreasing region 504. The bonding point 521 can be located at the midpoint on the x-axis or a point different from the midpoint on the x-axis.

FIG. 17 is a plan diagram of a beam 55 in still another embodiment of this disclosure. The beam 55 consists of two regions 554 and 555 lying side by side along the y-axis. The region 554 is a decreasing region where its width W1 decreases with the distance from the side (distal end) 591 of the load region.

The width W1 of the region 554 monotonically decreases from the side 591 of the load region toward the center of the beam 55 along the y-axis. The sides defining the width of the region 554 are straight. The shape of the region 554 is line-symmetric about the y-axis. The width W1 of the region 554 takes a minimum value at the boundary with the region 555.

The region 555 is a non-decreasing region where its width W4 is uniform. The width W4 takes the same value as the maximum value of the width W1 of the region 554. The side (distal end) 592 is a load region. The sides defining the width W4 of the region 555 are straight and parallel to the y-axis. The shape of the region 555 is a rectangle and it is line-symmetric about the y-axis.

The bonding point 571 of the strain gauge in FIG. 17 indicates the centroid of the bonded strain gauge. The bonding point 571 is located within the width decreasing region 554. The bonding point 571 can be located at the midpoint on the x-axis or a point different from the midpoint on the x-axis.

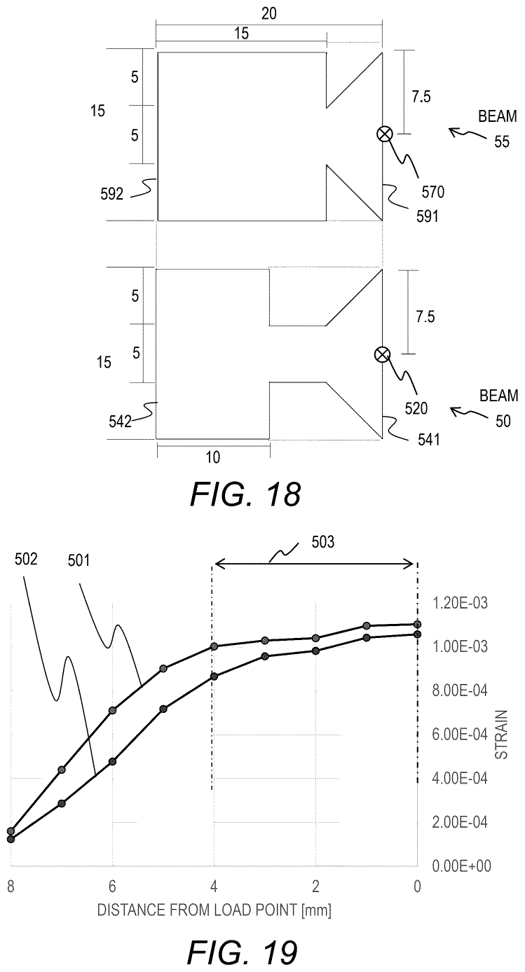

The effect of the width decreasing regions of the beams 50 and 55 to reduce the variations in strain is described. FIG. 18 provides specific examples of some dimensions of the beams 50 and 55. The unit of the numerical values is millimeters. Assume that the beams 50 and 55 are made of stainless steel and have a thickness of 2 mm.

The load point 570 of the beam 55 is a point on the side (distal end) 591 restrained in the x-axis direction and the y-axis direction. The opposite side 592 is restrained in the x-axis direction, the y-axis direction, and the z-axis direction. The load point 520 of the beam 50 is a point on the side 541 restrained in the x-axis direction and the y-axis direction. The opposite side (distal end) 542 is restrained in the x-axis direction, the y-axis direction, and the z-axis direction.

FIG. 19 provides results of a simulation where a force of 175 N in the z-axis direction is applied to the load points 570 and 520 of the beams 55 and 50. In the graph of FIG. 19, the horizontal axis indicates the distance from the load point. The vertical axis indicates the strain amount of the beam along the y-axis. The curve 501 represents the simulation result of the beam 50 and the curve 502 represents the simulation result of the beam 55. The line with arrows 503 indicates the width decreasing regions of the beams 50 and 55.

The simulation results 501 and 502 of the beams 50 and 55 indicate that the variation in strain amount in their width decreasing regions 503 are significantly small, compared to the result of the beam 3 in FIG. 7. Furthermore, the simulation result 501 of the beam 50 indicates that the variation in strain amount in the width decreasing region 503 is small, compared to that of the beam 55. As noted from these results, the width decreasing region can effectively decrease the variation in strain amount depending on the position. Furthermore, the configuration such that the width decreasing region is adjoining a rectangular region whose width is equal to the minimum width of the width decreasing region exhibits higher effect.

Regarding the shapes illustrated in FIGS. 14A to 17, the width decreasing region can have two opposite curved sides defining the width as illustrated in FIG. 11A. The shapes of the above-described plurality of beams are line-symmetric about the y-axis. In another embodiment of this disclosure, the shape of the beam can be asymmetric about the y-axis.

The force-sensor-stage-side end (e.g., the side 641A or 541) and the base-stage-side end (e.g., the side 641B or 542) of a beam can have an equal length or different lengths. From the standpoint of safety factor, the side (distal end) opposite the decreasing region where the strain gauge is bonded or the side (distal end) in the region where the strain gauge is not bonded can be equal to or longer than the side (distal end) in the decreasing region. Taking an example of the beam illustrated in FIG. 16, the side 542 can be equal to or longer than the side 541.

The beams in the above-described embodiments of this disclosure include a width decreasing region where to bond a strain gauge. In another embodiment of this disclosure, the beam can include a thickness decreasing region where to bond a strain gauge. The thickness decreasing region can reduce the variation in strain amount depending on the position of the bonding point of the strain gauge.

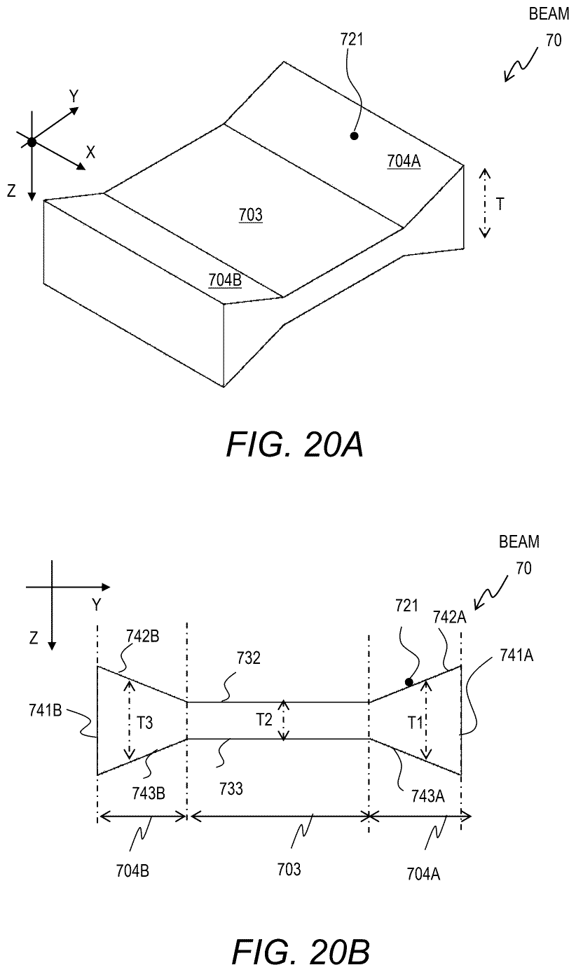

FIG. 20A is a perspective diagram of a beam 70. The beam 70 consists of three regions (parts), which are regions 704A, 703, and 704B lying side by side along the y-axis. The regions 704A and 704B are thickness decreasing regions where their thicknesses T vary along the y-axis and the mid-region 703 is sandwiched by those regions 704A and 704B. The point 721 is an example of the bonding point of the strain gauge. The strain gauge is disposed in a thickness decreasing region.

FIG. 20B is a cross-sectional diagram of the beam 70 cut perpendicularly to the x-axis. FIG. 20B is a cross-sectional diagram at the bonding point 721 of the strain gauge. The cross-sections of the beam 70 are identical at any positions on the x-axis. The region 704A is a thickness decreasing region where its thickness T1 decreases with the distance from the load region. The thickness T1 is the dimension along the z-axis. The side (distal end) 741A of the region 704A is the load region. The side 741A is the boundary between the region 704A and a not-shown fixture region. The fixture region can have a cuboid shape.

The thickness T1 of the region 704A monotonically decreases with the distance from the side 741A toward the center of the beam 70 along the y-axis. In the example of the shape in FIG. 20B, the sides 742A and 743A defining the thickness of the region 704A are straight. The shape of the region 704A is line-symmetric about the y-axis.

The region 704B is another thickness decreasing region where its thickness T3 decreases with the distance from the load region. The thickness T3 is the dimension along the z-axis. The side (distal end) 741B of the region 704B is a load region. The side 741B is the boundary between the region 704B and a not-shown fixture region. The fixture region can have a cuboid shape.

The thickness T3 of the region 704B monotonically decreases with the distance from the side 741B toward the center of the beam 70 along the y-axis. In the example of the shape in FIG. 20B, the sides 742B and 743B defining the thickness of the region 704B are straight. The shape of the region 704B is line-symmetric about the y-axis. The shapes of the regions 704B and 704A are line-symmetric about the z-axis.

The mid-region 703 sandwiched by the thickness decreasing regions 704A and 704B has a uniform thickness T2. The opposite sides 732 and 733 defining the thickness T2 are parallel to the y-axis. The thickness T2 takes the same value as the minimum values of the thicknesses T1 and T3 of the regions 704A and 704B.

An embodiment of this disclosure disposes the strain gauge within the thickness decreasing region. As a result, the variations in the output values of strain gauges caused by variations in their bonding points on the y-axis can be reduced. Furthermore, the thickness decreasing regions illustrated in FIGS. 20A and 20B have symmetric shapes about the y-axis. As a result, the variations in the output values of strain gauges caused by variations in their bonding points on the x-axis can be reduced.

For example, at least the centroid of the strain gauge is located in the thickness decreasing region. Moreover, the entire strain gauge can be included in the thickness decreasing region. The bonding point 721 in FIGS. 20A and 20B indicates the centroid of the bonded strain gauge. The bonding point 721 can be located at the midpoint on the x-axis or a point different from the midpoint on the x-axis.

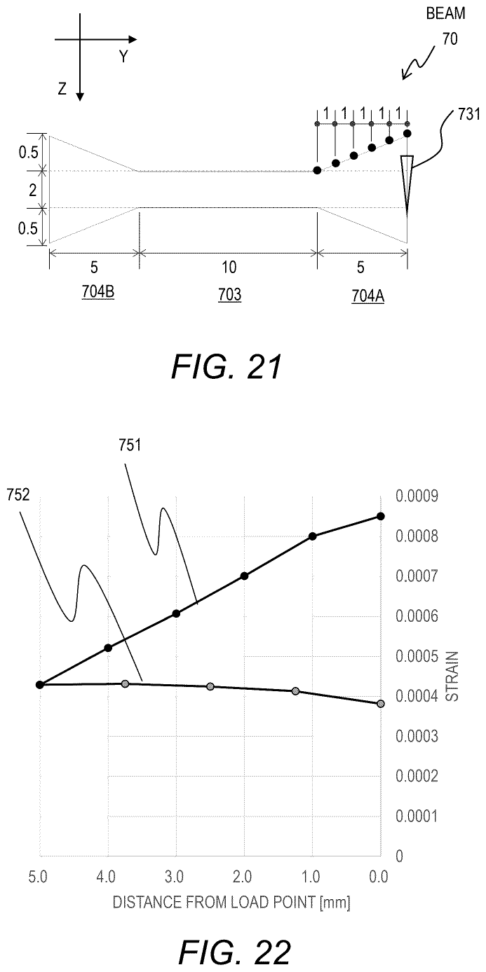

FIGS. 21 and 22 provide a result of a simulation on the strain amount in the thickness decreasing region. FIG. 21 provides dimensions of the beam 70 used in the simulation. The unit of the dimensions is millimeters. The dimension along the x-axis is 15 mm and the material is stainless steel. The load point 731 is located at the midpoint on the x-axis of the end face of the thickness decreasing region 704A.

FIG. 22 is a graph showing the simulation result. The horizontal axis indicates the distance from the load point and the vertical axis indicates the strain amount. The curve 751 represents the simulation result of a beam having a uniform thickness. Specifically, the beam is a cuboid having dimensions along the x-axis, y-axis, and z-axis of 15 mm, 20 mm, and 2 mm, respectively. The curve 752 represents the simulation result of the beam 70 illustrated in FIG. 21. FIG. 22 indicates that the variation in strain amount in the thickness decreasing region is significantly small, compared to that of the beam having a uniform thickness.

The thickness decreasing region can further have a decreasing width as described with reference to FIGS. 3A to 17.

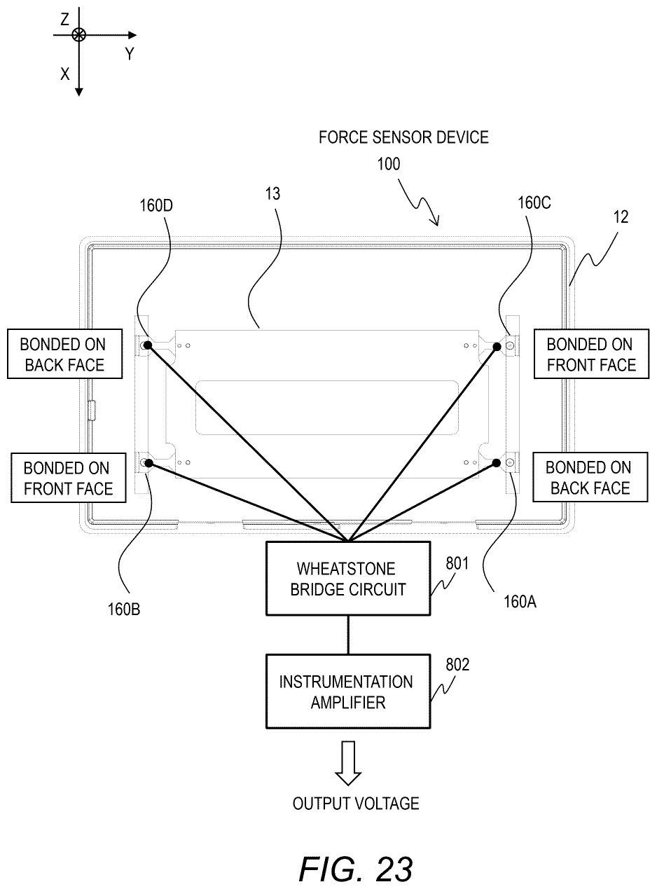

Hereinafter, measurement with strain gauges bonded on fixed beams is described. FIG. 23 illustrates a configuration example for measuring a load with strain gauges. In one embodiment of this disclosure, the force sensor device 100 measures a load with a Wheatstone bridge (WB) circuit 801. Strain gauges are disposed in the width decreasing regions of four beam components 160A to 160D.

Each beam is provided with only one strain gauge bonded thereto. The strain gauges for the beam components 160A and 160D are bonded on the back faces of the beam components and the strain gauges for the beam components 160B and 160C are bonded on the front faces of the beam components. The front faces are facing the force sensor stage 12.

The four strain gauges are incorporated in the Wheatstone bridge circuit 801. An instrumentation amplifier 802 amplifies the output of the Wheatstone bridge circuit 801. The instrumentation amplifier 802 and the components of the Wheatstone bridge circuit 801 except for the strain gauges can be included in the controller 20 shown in FIG. 1.

If the strain gauges have variations in their bonding points to the beams, the strains to be detected will be different, resulting in variations in the output values of the strain gauges. In the case of acquiring output values from a Wheatstone bridge circuit 801 using strain gauges on fixed beams, each product is required to calibrate the in-plane variations. As described above, the embodiments of this disclosure reduce the variations in the output values caused by variations in the bonding points of strain gauges.

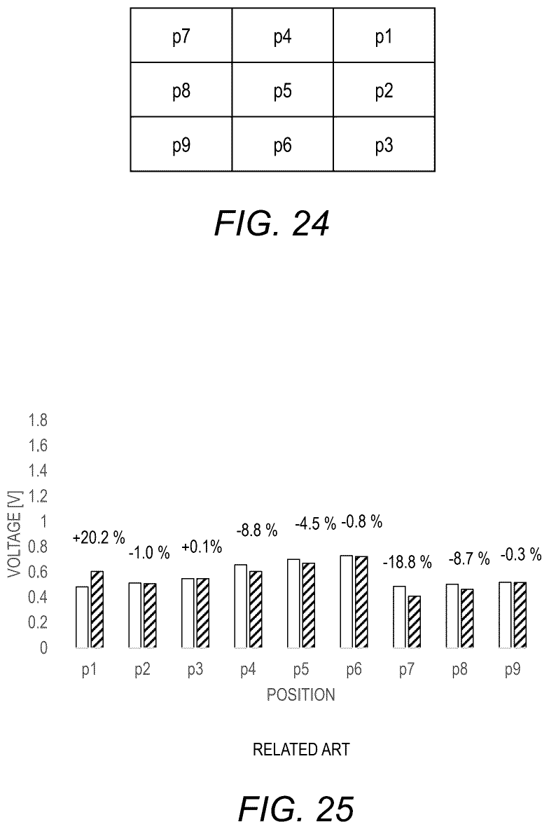

The effects of a beam having a width decreasing region are described. Results of a static loading simulation conducted on some different device configurations are described. The device configurations employed different shapes of beams in the configuration illustrated in FIG. 23. The simulation calculated the voltages output by the Wheatstone bridge circuit 801 when a load (a force of 5 N in the z-axis direction) is applied to each of the centers of the nine subregions p1 to p9, which are obtained by dividing the display screen as illustrated in FIG. 24.

FIG. 25 provides a simulation result of cuboid beams. In the graph of FIG. 25, the horizontal axis indicates the subregions of the display screen and the vertical axis indicates the output voltage from the Wheatstone bridge circuit 801. Regarding each subregion, the left bar indicates the output voltage when the strain gauges were bonded at the reference points and the right bar indicates the output voltage when one of the four strain gauges was displaced by 1 mm. The numerical value above the pair of bars for each subregion indicates the variation in output voltage.

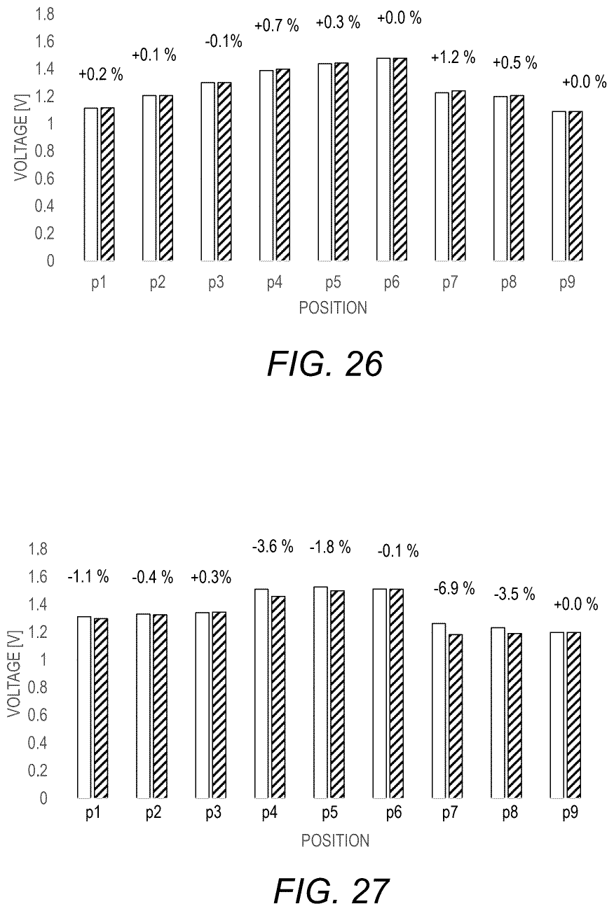

FIG. 26 provides a simulation result of beams 16 illustrated in FIG. 5. In the graph of FIG. 26, the horizontal axis indicates the subregions of the display screen and the vertical axis indicates the output voltage from the Wheatstone bridge circuit 801. Regarding each subregion, the left bar indicates the output voltage when the strain gauges were bonded at the reference points and the right bar indicates the output voltage when one of the four strain gauges was displaced by 1 mm. The numerical value above the pair of bars for each subregion indicates the variation in output voltage.

FIG. 27 provides a simulation result of beams 35 illustrated in FIG. 12. In the graph of FIG. 27, the horizontal axis indicates the subregions of the display screen and the vertical axis indicates the output voltage from the Wheatstone bridge circuit 801. Regarding each subregion, the left bar indicates the output voltage when the strain gauges were bonded at the reference points and the right bar indicates the output voltage when one of the four strain gauges was displaced by 1 mm. The numerical value above the pair of bars for each subregion indicates the variation in output voltage.

In comparison of the simulation result in FIG. 26 or 27 with the simulation result in FIG. 25, each variation in output voltage acquired from the beams having a width decreasing region is significantly improved from the corresponding variation acquired from the cuboid beams.

Some combinations of different numbers of strain gauges to be bonded and different circuit configurations of the Wheatstone bridge circuit are available. Each beam can be provided with up to four strain gauges. Commonly, one, two, or four strain gauges are bonded to one beam.

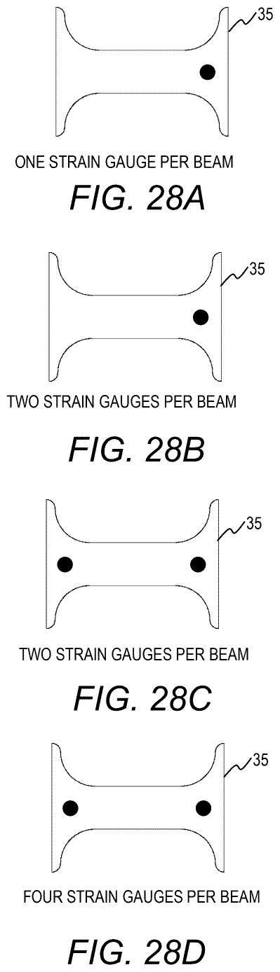

FIGS. 28A to 28D illustrate examples of the bonding layout of strain gauges on a beam. The layout in FIG. 28A is such that only one strain gauge is bonded on one width decreasing region. The layout in FIG. 28B is such that two strain gauges are bonded on the both faces of a width decreasing region. The layout in FIG. 28C is such that two strain gauges are bonded on the same one face of two width decreasing regions. The layout in FIG. 28D is such that four strain gauges are bonded on the both faces of two width decreasing regions.

Three types of Wheatstone bridge circuits are known. They are for the one-gauge method, the two-gauge method, and the four-gauge method. The circuit configuration for the one-gauge method includes one strain gauge; the circuit configuration for the two-gauge method includes two strain gauges; and the circuit configuration for the four-gauge method includes four strain gauges.

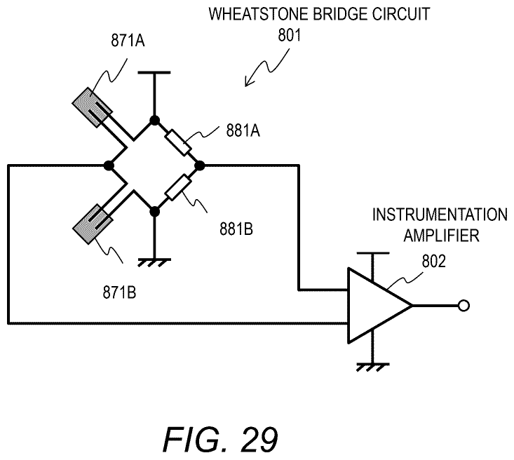

FIG. 29 illustrates a configuration example of a Wheatstone bridge circuit 801 for the two-gauge method. The Wheatstone bridge circuit 801 includes two strain gauges 871A and 871B and two resistor elements 881A and 881B. These are connected annularly. For the one-gauge method, either the strain gauge 871A or 871B is to be replaced with a resistor element. For the four-gauge method, the two resistor elements 881A and 881B are to be replaced with strain gauges.

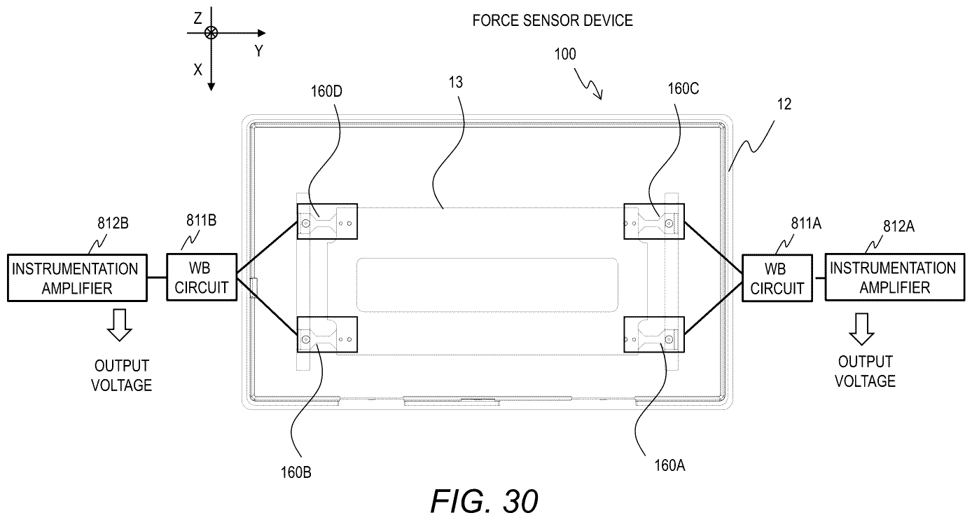

FIG. 30 illustrates a configuration example of a force sensor device 100 including two Wheatstone bridge circuits. The force sensor device 100 includes two Wheatstone bridge circuits 811A and 811B and two instrumentation amplifiers 812A and 812B for amplifying the outputs of the Wheatstone bridge circuits 811A and 811B, respectively.

The Wheatstone bridge circuit 811A includes the strain gauges on two beam components 160A and 160C and the Wheatstone bridge circuit 811B includes the strain gauges on two beam components 160B and 160D. The combination of the number of strain gauges bonded on each beam component (beam thereof) and the type of the Wheatstone bridge circuit can be one strain gauge×two-gauge method or two strain gauges×four-gauge method. Detection of a load and a touch point with respect to the y-axis becomes available by calibrating the combination of the balance between output voltages of the two Wheatstone bridge circuits 811A and 811B and the actual touch point.

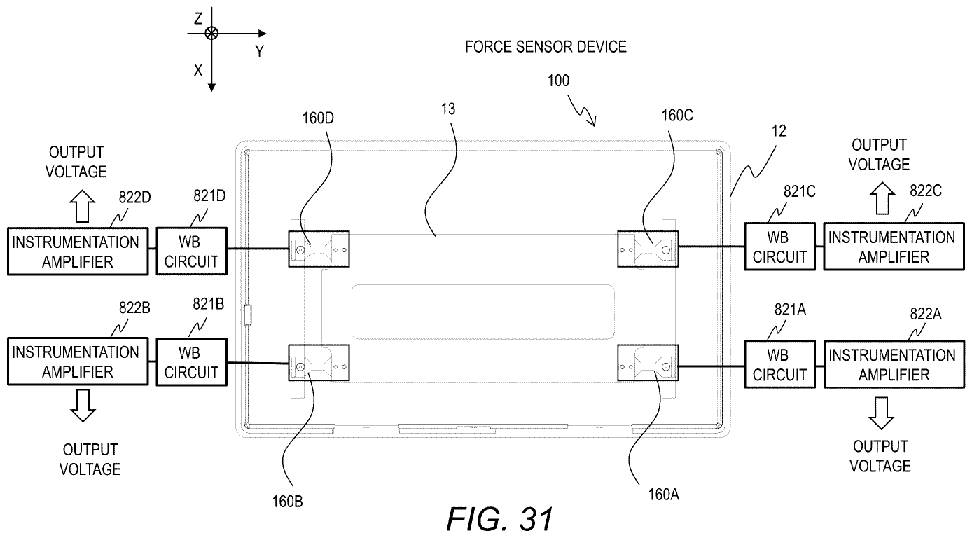

FIG. 31 illustrates a configuration example of a force sensor device 100 including four Wheatstone bridge circuits. The force sensor device 100 includes four Wheatstone bridge circuits 821A to 821D and four instrumentation amplifiers 822A to 822D for amplifying the outputs of the Wheatstone bridge circuits 821A to 821D, respectively.

The Wheatstone bridge circuit 821A includes the strain gauges on the beam component 160A; the Wheatstone bridge circuit 821B includes the strain gauges on the beam component 160B; the Wheatstone bridge circuit 821C includes the strain gauges on the beam component 160C; and the Wheatstone bridge circuit 821D includes the strain gauges on the beam component 160D.

The combination of the number of strain gauges bonded on each beam component (beam thereof) and the type of the Wheatstone bridge circuit can be one strain gauge×one-gauge method, two strain gauges×two-gauge method, or four strain gauges×four-gauge method. Detection of a load and a touch point with respect to the x-axis and the y-axis becomes available by calibrating the combination of the balance among the output voltages of the four Wheatstone bridge circuits 821A to 821D and the actual touch point.

The measurement method using four Wheatstone bridge circuits 821A to 821D is described. The coordinates of the load point to be conclusively determined by the controller 20 are expressed as (x5, y5), the load applied at the load point as W, the positions of four beams (e.g., the positions of their centroids) as (x1, y1), (x2, y2), (x3, y3), and (x4, y4); and the force applied thereto as F1, F2, F3, and F4. The following formulae are established from the proportion of the forces and the proportion of the moments:

$$W = F 1 + F 2 + F 3 + F 4 ,$$

$$x 5 W = x 1 F 1 + x 2 F 2 + x 3 F 3 + x 4 F 4 , and$$

$$y 5 W = y 1 F 1 + y 2 F 2 + y 3 F 3 + y 4 F 4$$

The load F to a fixed beam is expressed by the following formula, using the strain ϵ detected by the strain gauges on the beams and the Wheatstone bridge circuit, the modulus of elasticity (Young's modulus) E, the cross-sectional area A of the beam, and the stress σ:

$$F = A σ = A = AE ε .$$

The loads F1, F2, F3, and F4 to the individual beams can be calculated by this formula.

Since the coordinates of the beams (x1, y1), (x2, y2), (x3, y3), and (x4, y4) are known, the coordinates (x5, y5) of the load point and the load W there can be calculated from the calculated F1, F2, F3, and F4.

According to an embodiment of this disclosure, the beam to be provided with a strain gauge is shaped in such a manner that its width monotonically decreases from a distal end toward the center and the strain gauge is bonded to a region where its width monotonically decreases. As a result, even if a plurality of strain gauges have variations in their bonding points, the output values of the strain gauges have a small variation and therefore, the calibration becomes unnecessary.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A force sensor device comprising:
a first stage;
a second stage disposed behind the first stage with a gap therebetween;
a plurality of beams fixed to the second stage and the first stage; and
strain gauges attached on the plurality of beams,
wherein the first stage is configured to move relatively to the second stage in response to a force applied from the front,
wherein the plurality of fixed beams are configured to deform with the movement of the first stage,
wherein each of the plurality of beams includes a decreasing region where at least either the width or the thickness monotonically decreases from a first fixing point to one of the first stage and the second stage toward a second fixing point to the other one of the first stage and the second stage, and
wherein each strain gauge is attached within the decreasing region.

2. The force sensor device according to claim 1, wherein the width of the decreasing region monotonically decreases from the first fixing point toward the second fixing point.

3. The force sensor device according to claim 2, wherein the decreasing region has a line-symmetric shape about an axis of symmetry extending in a first direction directed from the first fixing point toward the second fixing point.

4. The force sensor device according to claim 3, wherein each beam has a line-symmetric shape about an axis of symmetry extending in a second direction perpendicular to the first direction and a direction of a load to the beam.

5. The force sensor device according to claim 2, wherein sides defining the width of the decreasing region are straight.

6. The force sensor device according to claim 2, wherein sides defining the width of the decreasing region are curved.

7. The force sensor device according to claim 2,
wherein the decreasing region is a first width decreasing region,
wherein the force sensor device further comprises:
a second width decreasing region having a width monotonically decreasing from the second fixing point toward the first fixing point,
a mid-region between the first width decreasing region and the second width decreasing region,
wherein the width at the boundary of the mid-region with the first width decreasing region is equal to the minimum width of the first width decreasing region, and
wherein the width at the boundary of the mid-region with the second width decreasing region is equal to the minimum width of the second width decreasing region.

8. The force sensor device according to claim 2, wherein each beam has a line-symmetric shape about an axis of symmetry extending perpendicularly to a direction directed from the first fixing point toward the second fixing point and a direction of a load to the beam.

9. The force sensor device according to claim 1, wherein each strain gauge is included in a Wheatstone bridge circuit.

10. An electronic device comprising:
the force sensor device according to claim 1; and
a display device mounted in front of the first stage.

11. The electronic device according to claim 10, further comprising:
an actuator configured to vibrate the display device to provide tactile stimulus to a user.
